(19) United States
(12) Patent Application Publication
(10) Pub. No.: US 2014/0031063 A1
(43) Pub. Date: Jan. 30, 2014

(54) METHOD FOR TRANSMITTING AND RECEIVING PARAMETER UPDATE INFORMATION, AND APPARATUS FOR SAME

(71) Applicants: Giwon Park, Anyang-si (KR); Youngsoo Yuk, Anyang-si (KR)

(72) Inventors: Giwon Park, Anyang-si (KR); Youngsoo Yuk, Anyang-si (KR)

(73) Assignee: LG Electronics Inc., Seoul (KR)

(21) Appl. No.: 14/009,986

(22) PCT Filed: Apr. 5, 2012
(86) PCT No.: PCT/KR2012/002576

§ 371 Date: Oct. 4, 2013

Related U.S. Application Data
(60) Provisional application No. 61/472,592, filed on Apr. 6, 2011.
(60) Provisional application No. 61/486,733, filed on May 16, 2011.
(60) Provisional application No. 61/501,719, filed on Jun. 27, 2011.

(51) Int. Cl. H04W 4/00

(52) U.S. Cl. CPC H04W 4/005
USPC 455/456.1

(57) ABSTRACT

Disclosed are a method for transmitting and receiving parameter update information and an apparatus for same. A machine to machine (M2M) device for receiving parameter update information according to the present invention comprises: a receiver for receiving, from a base station (BS), a first message containing information indicating that the M2M device belonging to a specific M2M group should perform a location update; and a transmitter for transmitting a second message for location update to the base station. The receiver further receives, from the base station (BS), a third esage as a response to the second message, wherein the third message may further include information on a new M2M group identifier for the M2M device that belongs to the specific M2M group. Here, the first message may be a paging message, the second message may be a ranging request message, and the third message may be a ranging response message.

### FIELD OF THE INVENTION

The present invention relates to wireless communication, and more particularly to a method and apparatus for transmitting and receiving parameter update information.

### BACKGROUND ART

Machine-to-machine (M2M) communication is communication between electronic devices as the name implies. While M2M communication means wired or wireless communication between electronic devices or communication between a human-controlled device and a machine in the broadest sense, these days M2M communication typically refers to wireless communication between electronic devices.

When the concept of M2M communication was introduced in the early 1990s, it was regarded merely as the concept of remote control or telematics and the market therefor was very limited. However, M2M communication has been rapidly developed and the M2M communication market has attracted much attention all over the world over the past few years. Especially, M2M communication has a great influence in the fields of fleet management, remote monitoring of machines and facilities, smart metering for automatically measuring the working time of construction equipment and the consumption of heat or electricity, etc. in the Point Of Sales (POS) market and security-related applications. It is expected that M2M communication will find various uses in conjunction with legacy mobile communication, very high-speed wireless Internet or Wireless Fidelity (WiFi), and low-output communication solutions such as ZigBee and thus will extend to Business to Customer (B2C) markets beyond Business to Business (B2B) markets.

In the era of M2M communication, every machine equipped with a Subscriber Identity Module (SIM) card can be managed and controlled remotely because it is possible to transmit data to and receive data from the machine. For example, M2M communication is applicable to a very broad range including numerous terminals and equipment such as a car, a truck, a train, a container, an automatic vending machine, a gas tank, etc.

Conventionally, user equipments (UEs) are generally managed on an individual basis and thus a one-to-one communication environment is established between a Base Station (BS) and UEs. Considering a large number of M2M terminals in this environment, network overload is expected due to signaling between the BS and individual M2M terminals. As described above, if M2M communication gets rapidly popular and widespread, overhead caused by communication between M2M terminals or between a BS and M2M terminals may lead to a problem.

However, assuming that parameters (or control parameters) associated with either each M2M device or M2M devices of an M2M group for use in a wireless communication system supporting M2M device communication are changed to other parameters (or other control parameters), there is a need to provide a method for efficiently providing the changed parameters (or control parameters). However, the above-mentioned method has not yet been disclosed.

### DETAILED DESCRIPTION OF THE INVENTION

### Technical Problem

An object of the present invention is to provide a method for transmitting parameter update information by a base station (BS) in a wireless communication system.

Another object of the present invention is to provide a method for receiving parameter update information by a Machine to Machine (M2M) device in a wireless communication system.

Another object of the present invention is to provide a base station (BS) for transmitting parameter update information in a wireless communication system.

Another object of the present invention is to provide an M2M device for receiving parameter update information in a wireless communication system.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for transmitting parameter update information by a base station (BS) in a wireless communication system including: transmitting a first message including specific information indicate that at least one M2M device contained in a specific M2M (Machine to Machine) needs to perform a location update, to the at least one M2M device; receiving a second message for the location update from the at least one M2M device; and transmitting a third message as a response to the second message to the at least one M2M device, wherein the third message includes new M2M group identifier (ID) information of the at least one M2M device belonging to the specific M2M group. The first message may be a paging message, the second message may be a ranging request message, and a third message may be a ranging response message. The at least one M2M device contained in the specific M2M group may operate in an idle mode. The paging message may correspond to a paging message based on an M2M group.

In another aspect of the present invention, a method for receiving parameter update information by an M2M (Machine to Machine) device in a wireless communication system includes: receiving a first message including specific information indicates that at least one M2M device contained in a specific M2M (Machine to Machine) group needs to perform a location update, from a base station (BS); transmitting a second message for the location update from the at least one M2M device; and receiving a third message as a response to the second message from the base station (BS), wherein the third message includes new M2M group identifier (ID) information of the at least one M2M device belonging to the specific M2M group. The first message may be a paging message, the second message may be a ranging request message, and a third message may be a ranging response message.

The at least one M2M device contained in the specific M2M group may operate in an idle mode. The paging message may correspond to a paging message based on an M2M group.

In another aspect of the present invention, a base station (BS) for transmitting parameter update information in a wireless communication system includes: a transmitter configured to transmit a first message including specific information indicates that at least one M2M device contained in a specific M2M (Machine to Machine) group needs to perform a location update, to the at least one M2M device; and a receiver configured to receive a second message for the location update from the at least one M2M device, wherein the transmitter further transmits a third message as a response to the second message to the at least one M2M device, and the third message includes new M2M group identifier (ID) information of the at least one M2M device belonging to the specific M2M group.

In another aspect of the present invention, a Machine to Machine (M2M) device for receiving parameter update information in a wireless communication system includes: a receiver configured to receive a first message including specific information indicates that the M2M device contained in a specific M2M (Machine to Machine) group needs to perform a location update, from a base station (BS); and a transmitter configured to transmit a second message for the location update from the base station (BS), wherein the receiver further receives a third message as a response to the second message from the base station (BS), and the third message includes new M2M group identifier (ID) information of the M2M device belonging to the specific M2M group. The first message may be a paging message, the second message may be a ranging request message, and a third message may be a ranging response message. The paging message may correspond to a paging message based on an M2M group.

### Effects of the Invention

As is apparent from the above description, exemplary embodiments of the present invention can allow M2M devices to receive updated parameter information according to the proposed process, and can perform efficient communication using the updated parameter values. In addition, a base station (BS) can efficiently provide updated parameters for a large number of M2M devices, such that it can reduce overhead and improve network communication throughput.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a block diagram illustrating an M2M device and a BS device according to an embodiment.

FIG. 2 is a flowchart illustrating a method for requesting retransmission of a paging message when an M2M device does not receive a paging message according to one embodiment of the present invention.

FIG. 3 is a flowchart illustrating a method for requesting a paging message when an M2M device does not receive a paging message according to another embodiment of the present invention.

FIG. 4 is a flowchart illustrating a method for allowing an M2M device to request transmission of an AAI-PAG-ADV message update location update according to embodiments.

### BEST MODE FOR CARRYING OUT THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts. It should be noted that specific terms disclosed in the present invention are proposed for convenience of description and better understanding of the present invention, and the use of these specific terms may be changed to other formats within the technical scope or spirit of the present invention.

For example, the following description will be given centering upon a mobile communication (wireless communication) system serving as an IEEE 802.16 system, but the present invention is not limited thereto and the remaining parts of the present invention other than unique characteristics of the 3GPP LTE or LTE-A system are applicable to other mobile communication systems. In the following description, a terminal may refer to a mobile or fixed user equipment (UE), for example, a user equipment (UE), a mobile station (MS) and the like. Also, the base station (BS) may refer to an arbitrary node of a network end which communicates with the above terminal, and may include an eNode B (eNB), a Node B (Node-B), an access point (AP) and the like.

In a mobile communication system, the UE may receive information from the base station (BS) via a downlink, and may transmit information via an uplink. The information that is transmitted and received to and from the UE includes data and a variety of control information. A variety of physical channels are used according to categories of transmission (Tx) and reception (Rx) information of the UE.

The following embodiments of the present invention can be applied to a variety of wireless access technologies, for example, CDMA, FDMA, TDMA, OFDMA, SC-FDMA, MC-FDMA, and the like. CDMA can be implemented by wireless communication technologies, such as Universal Terrestrial Radio Access (UTRA) or CDMA2000. TDMA can be implemented by wireless communication technologies, for example, Global System for Mobile communications (GSM), General Packet Radio Service (GPRS), Enhanced Data rates for GSM Evolution (EDGE), etc. OFDMA can be implemented by wireless communication technologies, for example, IEEE 802.11 (Wi-Fi), IEEE 802.16 (WiMAX), IEEE 802.20, E-UTRA (Evolved UTRA), and the like. UTRA is a part of the Universal Mobile Telecommunications System (UMTS). 3rd Generation Partnership Project (3GPP) Long Term Evolution (LTE) is a part of Evolved UMTS (E-UMTS) that uses E-UTRA. The LTE—Advanced (LTE-A) is an evolved version of 3GPP LTE.

Hereinafter, M2M communication refers to communication between Mobile Stations (MSs) via a Base Station (BS), between a BS and MSs without human intervention, or between M2M devices. Accordingly, M2M devices refer to MSs which can support the above M2M communication. An Access Service Network (ASN) for an M2M service is defined as an M2M ASN and a network entity communicating with M2M devices is called an M2M server. The M2M server executes an M2M application and provides an M2M specific service for one or more M2M devices. An M2M feature indicates the feature of an M2M application and one or more features may be necessary to provide the application. An M2M device group refers to a group of M2M devices which share one or more common features.

Such a terminal that communicates in an M2M manner as described above can be referred to as an M2M device, an M2M communication terminal, or a Machine Type Communication (MTC) terminal. M2M devices will gradually increase in number in a given network as machine application types thereof increase. Machine application types under consideration are (1) security; (2) public safety; (3) tracking and tracing; (4) payment; (5) healthcare; (6) remote maintenance and control; (7) metering; (8) consumer devices; (9) fleet management in Point Of Sale (POS)-related and security-related application markets; (10) M2M communication at a vending machine; (11) remote control of machines and facilities and smart metering for automatically measuring the operation time of construction equipment and facilities and heat or power consumption; and (12) surveillance video communication, which should not be construed as limiting the present invention. Besides, many other machine application types are being discussed.

Hereinafter, the exemplary embodiments of the present invention will be described when M2M communication is applied to a wireless communication system (e.g. IEEE 802.16 e/m). However, the scope or spirit of the present invention is not limited thereto and is applicable to other communication systems such as 3GPP LTE systems.

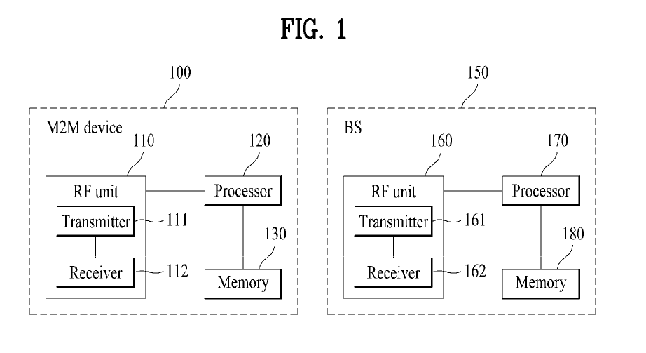

FIG. 1 is a diagram schematically explaining the configuration of an M2M device and a BS device according to an exemplary embodiment of the present invention.

Referring to FIG. 1, an M2M device 100 (which may also be called an M2M communication device) may include a Radio Frequency (RF) unit 110 and a processor 120. A BS 150 may include an RF unit 160 and a processor 170. The M2M device 100 and the BS 150 may selectively include memories 130 and 180, respectively. The RF units 110 and 160 may respectively include transmitters 111 and 161, and receivers 112 and 162. The transmitter 111 and the receiver 112 of the M2M device 100 are configured to transmit and receive signals to and from the BS 150 and other M2M devices. The processor 120 is functionally connected to the transmitter 111 and the receiver 112 so that the processor 120 may control the transmitter 111 and the receiver 112 to exchange signals with other devices. The processor 120 may process signals to be transmitted and transmit the processed signals to the transmitter 111. The processor 120 may process signals received by the receiver 112. If necessary, the processor 120 may store information included in exchanged messages in the memory 130. With such a configuration, the M2M device 100 may perform methods of various embodiments of the present invention which will be described below. Meanwhile, although not shown in FIG. 1, the M2M device 100 may additionally include a variety of configurations according to an application type thereof. For example, if the M2M device 100 is for intelligent metering, the M2M device 100 may include an additional configuration for power measurement, and an operation for such power measurement may be controlled by the processor 120 shown in FIG. 1 or an additionally configured processor (not shown).

Although, in FIG. 1, the case in which communication between the M2M device 100 and the BS 150 is performed is shown by way of example, an M2M communication method according to the present invention may be performed between one or more M2M devices, and each device may carry out methods according to various embodiments, which will be described below, with the same configuration as that of the device shown in FIG. 1.

The transmitter 161 and the receiver 162 of the BS 150 are configured to transmit and receive signals to and from other BSs, M2M servers, and M2M devices. The processor 170 is functionally connected to the transmitter 161 and the receiver 162 so that the processor 170 may control the transmitter 161 and the receiver 162 to exchange signals with other devices. The processor 170 may process signals to be transmitted and transmit the processed signals to the transmitter 161. The processor 170 may process signals received by the receiver 162. If necessary, the processor 170 may store information included in exchanged messages in the memory 180. With such a configuration, the BS 150 may perform methods of various embodiments of the present invention which will be described below.

The processors 120 and 170 of the M2M device 110 and the BS 150 direct (e.g. control, adjust, manage, etc.) operations of the M2M 110 and the BS 150, respectively. The processors 120 and 170 may be respectively connected to the memories 130 and 180 which store program codes and data. The memories 130 and 180 connected respectively to the processors 120 and 170 store operating systems, applications, and general files.

Each of the processors 120 and 170 of the present invention may be called a controller, a microcontroller, a microcomputer, etc. Meanwhile, each of the processors 120 and 170 may be implemented by hardware, firmware, software, or combinations thereof. When the embodiments of the present invention are implemented using hardware, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), or the like, devised to perform the present invention, may be included in the processors 120 and 170.

Meanwhile, when the embodiments of the present invention are implemented using firmware or software, the firmware or software may be configured to include a module, a procedure, or a function which performs the function or operation of the present invention. The firmware or software configured to be able to perform the present invention may be included in the processors 120 and 170 or may be stored in the memories 130 and 180 so as to be executed by the processors 120 and 170.

An idle mode for use in IEEE 802.16e, IEEE 802.16m, and IEEE 802.16p systems will hereinafter be described. The term “idle mode” refers to a mode in which a paging group, a paging cycle, and a paging offset approved by the base station (BS) are used through signaling between the M2M device and the base station (BS) for power saving of the M2M device. That is, according to this mechanism, the M2M device can receive a downlink broadcast message at regular intervals without being registered with a specific base station (BS) even when the M2M device moves in a radio link environment in which a plurality of BSs is present over a broad area.

In the idle mode, not only a handover (HO) operation but also all normal operations are deactivated while only downlink synchronization is achieved to enable reception of a paging message, which is a broadcast message, only within a specific interval. The paging message instructs the M2M device to perform a paging action. For example, the paging action includes ranging and network reentry.

The idle mode may be initiated by the M2M device (i.e., MS or UE) or the BS. That is, the M2M device may enter the idle mode by transmitting a deregistration request (DREG-REQ) message to the BS and receiving a deregistration response (DREG-RSP) message from the BS in response to the DREG-REQ message. The BS may also enter the idle mode by transmitting an unrequested deregistration response (DREG-RSP) message or a deregistration command (DREG-CMD) to the M2M device in response to the DREG-REQ message.

When the M2M device (i.e., MS or UE) has received a paging message corresponding to the M2M device during an Available Interval (AI) in the idle mode, the M2M device switches to a connected mode through a network entry procedure with the BS to transmit and receive data to and from the BS.

The idle state or idle mode generally allows the M2M device to transmit downlink broadcast traffic at regular intervals without being registered with a specific BS when the M2M device moves in a radio link environment in which multiple BSs are present. The M2M device may switch to the idle mode in order to achieve power saving when the M2M device has not received traffic from a base station for a predetermined time. The M2M device, which has switched to the idle mode, may receive a broadcast message (for example, a paging message) broadcast by the BS during an Available Interval (AI) and determine whether the M2M device will switch to the normal mode or remains in the idle state.

In the idle state, it is possible to give a benefit to the M2M device by removing handover-related activation requirements and general operation requirements. The idle mode may restrict the activity of the M2M device to be scanned in a discrete period so as to conserve power and operational resources used by the M2M device. In addition, the idle mode may provide a simple appropriate scheme for informing the M2M device of pending downlink (DL) traffic, and eliminate radio interface and network handover (HO) traffic from an inactive M2M device so as to provide benefits to a network and a BS.

The term “paging” refers to a function to determine the location of an M2M device (for example, a base station or a switching center) when a terminated call for the M2M device is generated during mobile communication. A number of BSs that support the idle state or the idle mode may belong to a specific paging group and constitute a paging area. Here, the paging group is a logical group. The purpose of the paging group is to provide an adjacent region that enables paging in downlink when traffic destined for the M2M device is present. It is preferable that the paging group be configured so as to satisfy a condition that the paging group is large enough that the M2M device is mostly present within the same paging group and a condition that the paging group is small enough to keep paging load at an appropriate level.

The paging group may include one or more BSs and one BS may be included in one or more paging groups. The paging group is defined in a management system. A paging group-action backbone network message may be used in the paging group. The paging controller may manage initial paging of all BSs belonging to the paging group and manage a list of M2M devices, which are in an idle state, using a paging-announce message which is a backbone message.

Paging in the idle mode is described below with reference to an IEEE 802.16 system for ease of explanation. However, the spirit of the present invention is not limited to the IEEE 802.16 system. An M2M device transmits a deregistration request (DREG-REQ) message to a BS to request deregistration from the BS in order to enter an idle mode. Thereafter, the BS transmits a deregistration response (DREG-RSP) message to the M2M device as a response to the DREG-REQ message. Here, the DREG-RSP message includes paging information. Here, a procedure for the M2M device to enter the idle mode may be initiated upon request of the BS. In this case, the BS transmits a DREG-RSP message to the M2M device.

The paging information may include a paging cycle, a paging offset, a Paging Group IDentifier (PGID), and a paging listening interval value.

When the M2M device has received a DREG-RSP message from the BS, the M2M device enters an idle mode with reference to the paging information. The idle mode may include a paging cycle(s), each of which may include an available interval and an unavailable interval. Here, the available interval is conceptually identical to the paging listening interval or the paging interval. The paging offset is used to indicate a time point (for example, a start or subframe) at which the paging interval starts in the paging cycle. The paging group identifier (PGID) indicates an identifier of the paging group allocated to the M2M device. The paging information may include paging message offset information. The paging message offset information indicates a time point at which a paging message is transmitted from the BS. Thereafter, the M2M device may receive a paging message destined for the M2M device within an available interval (or paging listening interval) using the paging information. Here, the paging message may be transmitted through the BS or the paging controller. That is, the M2M device monitors a radio frequency (RF) channel according to the paging cycle in order to receive the paging message.

When the M2M device is in an idle mode, the M2M device receives a paging message within a paging listening interval for the M2M device to determine whether or not downlink (DL) data destined for the M2M device is present. If downlink data for the M2M device is present (i.e., when the paging message includes a positive indication), the M2M device performs a network reentry procedure including a ranging process. Thereafter, a procedure for establishing a connection for an associated downlink service flow is performed through a Dynamic Service Addition (DSA) procedure. After the connection for the service flow is established, the BS transmits downlink data for the service to the M2M device.

The following description will hereinafter be disclosed on the basis of IEEE 802.16e, 16m, 16p systems. However, the scope or spirit of the present invention is not limited thereto.

The M2M device transmits a deregistration request (DREG-REQ) message to a BS to request deregistration from the BS in order to enter an idle mode. Thereafter, the BS transmits a deregistration response (DREG-RSP) message to the M2M device as a response to the DREG-REQ message. Here, the DREG-RSP message includes paging information. Here, a procedure for the M2M device to enter the idle mode may be initiated upon request of the BS. In this case, the BS transmits a DREG-RSP message to the M2M device.

The paging information may include a paging cycle, a paging offset, a Paging Group IDentifier (PGID), and a paging listening interval value. When the M2M device has received a DREG-RSP message from the BS, the M2M device enters an idle mode with reference to the paging information.

The idle mode may include a paging cycle(s), each of which may include an available interval and an unavailable interval. Here, the available interval is conceptually identical to the paging listening interval or the paging interval. The paging offset is used to indicate a time point (for example, a start or subframe) at which the paging interval starts in the paging cycle. The paging group identifier (PGID) indicates an identifier of the paging group allocated to the M2M device. The paging information may include paging message offset information. The paging message offset information indicates a time point at which a paging message is transmitted from the BS.

Thereafter, the M2M device may receive a paging message destined for the M2M device within an available interval (or paging listening interval) using the paging information. Here, the paging message may be transmitted through the BS or the paging controller. That is, the M2M device monitors a radio frequency (RF) channel according to the paging cycle in order to receive the paging message.

<Method 1 for Updating Reliable Control Parameters for the M2M Device Through a Paging Message>

The embodiment of the present invention provides a method for enabling a base station (BS) to update control parameters for an M2M device through a paging message as shown in Tables 1 and 2. However, assuming that the BS updates control parameters through the paging message, there is a need to provide a method for enabling the M2M device to successfully receive the paging message, and the BS must recognize whether the M2M device correctly updates the control parameters.

Table 1 shows an example of a paging message (e.g., AAI-PAG-ADV message) for group based paging.

TABLE 1

| | Size | | |
|---|---|---|---|
| Field | (bits) | Value/Description | Condition |
| Paging_Group_IDs | L | Indicate that the paging | L equals the |
| bitmap | | information for the | Num_PGIDs in PGID- |
| | | corresponding paging | Info message |
| | | group is included in AAI- | |
| | | PAG-ADV message. The | |
| | | length of | |
| | | Paging_Group_IDs bitmap | |
| | | is same as Num_PGIDs in | |
| | | PGID-Info message. | |
| | | 0: the paging information | |
| | | for the corresponding | |
| | | PGID is not included | |
| | | 1: the paging information | |
| | | for the corresponding | |
| | | PGID is included | |
| For (i=0; i<M; i++) { | | | M equals the number of |
| | | | bits in |
| | | | Paging_Group_IDs |
| | | | bitmap whose bit is set |
| | | | to 1. |
| For (j=0; | | Num_AMSs indicates the | |
| j<Num_AMSs; j++) { | | number of paged AMSs in | |
| | | a corresponding paging | |
| | | group | |
| | | 1..32 | |
| Deregistration | 18 | Used to indicate | Present if the Network |
| Identifier | | Deregistration ID for the | Configuration |
| | | MS to be paged | bit == 0b0 |
| Mac Address Hash | 24 | used to identify the AMS | Present if the Network |
| | | to be paged | Configuration |
| | | | bit == 0b01 |
| Paging cycle | 4 | Used to indicate Paging | Present if the S-SFH |
| | | cycle for the | Network Configuration |
| | | AMS to be paged | bit == 0b0 |
| | | 0x00: 4 superframes | |
| | | 0x01: 8 superframes | |
| | | 0x02: 16 superframes | |
| | | 0x03: 32 superframes | |
| | | 0x04: 64 superframes | |
| | | 0x05: 128 superframes | |
| | | 0x06: 256 superframes | |
| | | 0x07: 512 superframes | |
| | | 0x08-0x15: reserved | |
| Action code | 1 | Used to indicate the | |
| | | purpose of the AAI-PAG- | |
| | | ADV message | |
| | | 0b0: perform network | |
| | | reentry | |
| | | 0b1: perform ranging for | |
| | | location update | |
| } | | | |
| } | | | |
| for (i=0; i< Num_M2M | | | |
| Group; i++) { | | | |
| M2M Group ID | TBD | Used to indicate M2M | |
| (MGID) | | Group ID for the M2M | |
| | | Group to be paged. | |
| m | 2 | Time domain hash | Shall be present when |
| | | parameter (1 ~ 4) used to | the Bit #0, 2, 3 in |
| | | determine the frame index | Action Bitmap are set |
| | | of a superframe for M2M | to 1 and Action type is |
| | | Individual paging message | set to 1. |
| | | transmission of an idle | |
| | | mode M2M device. | |
| Action Bitmap | 4 | Bit #0: Perform the | |
| | | network reentry | |
| | | Bit #1: Receives the | |
| | | multicast traffic | |
| | | Bit #2: Perform ranging | |
| | | for location update | |
| | | Bit #3: Updates control | |
| | | parameters | |
| if (Bit #3 in Action | | | |
| Bitmap == 1) { | | | |
| Paging Unavailable | TBD | Paging Unavailable | Presented if it needs to |
| Interval | | Interval to the M2M | be updated. |
| | | device | |
| Paging Cycle | TBD | Paging cycle applied to the | Presented if it needs to |
| | | M2M device | be updated. |
| M2M Group ID | TBD | Used to indicate M2M | Presented if it needs to |
| (MGID) | | Group ID for the M2M | be updated. |
| | | Group to be paged. | |
| UL forbidden time | TBD | Time duration to prohibit | Presented if it needs to |
| | | M2M devices from | be updated. |
| | | ranging request for re- | |
| | | entry or location update for | |
| | | SMS within paging | |
| | | unavailable interval(s). | |
| Start offset | TBD | This field is start offset of | Presented if it needs to |
| | | UL forbidden time from | be updated. |
| | | the end of paging listening | |
| | | interval(s). | |
| Group security key | | Group security key | |
| | | allocated to each M2M | |
| | | group. Group security key | |
| | | is used to encrypt each | |
| | | MAC message. Individual | |
| | | paging message is also | |
| | | encrypted by the | |
| | | corresponding key, and | |
| | | then transmitted. | |
| } | | | |
| } //End of If (Bit #3 in | | | |
| Action Bitmap == 1) | | | |
| } //End of for (i=0; i< | | | |
| Num_M2M Group; | | | |
| i++) | | | |
| Extension Flag | 1 | Used to indicate the | |
| | | remaining part of the AAI- | |
| | | PAG-ADV message exists | |
| | | 0b0: this is the last | |
| | | fragment of the AAIPAG- | |
| | | ADV message | |
| | | 0b1: this is not the last | |
| | | fragment of the AAI-PAG- | |
| | | ADV message; the | |
| | | remaining fragments of the | |
| | | message will be | |
| | | transmitted in the | |
| | | subsequent subframes or | |
| | | frames. | |
| Emergency Alert | 1 | Used to indicate the | Optional |
| Indication | | presence of emergency | Present if there is |
| | | information | emergency information |
| | | 0b0: reserved | |
| | | 0b1: there is emergency | |
| | | information | |

If MGID of M2M devices contained in a multicast group needs to be changed to another, the BS transmits the paging message shown in Table 1 to the M2M device such that it can perform triggering of (group) location update.

Referring to Table 1, the paging message (AAI-PAG-ADV) may include a specific field (Paging_Group_IDs bitmap) indicating whether or not paging information of a paging group is included. For example, if the ‘Paging_Group_IDs bitmap’ field is set to zero (0), this field means that paging information of the corresponding paging group ID (PGID) is not included. If the ‘Paging_Group_IDs bitmap’ field is set to 1, this field means that paging information of the PGID is included. In addition, the AAI-PAG-ADV message may further include an MGID field for indicating an M2M group ID for a paged M2M group and an ‘action bitmap’ field for indicating an action type. If the ‘action bitmap’ field is set to ‘bit #2’, this means that ranging will be executed for location update. In addition, if the ‘action bitmap’ field is set to ‘bit #3’, this means that a control parameter needs to be updated. If the ‘action bitmap’ field is set to ‘bit #3’, the AAI-PAG-ADV message may further include a paging unavailable interval field, a paging cycle field, an MGID field, etc.

If the ‘action bitmap’ field of the AAI-PAG-ADV message is set to ‘bit #2’, the processor 120 of the M2M device can recognize that ranging for location update must be executed. Thereafter, the M2M device may transmit a ranging request message for location update to the BS. If location update has been successful, the BS may indicate the success of location update through the ranging response message (for example, AAI-RNG-RSP message), and may include updated MGID information into the AAI-RNG-RSP message and transmit the resultant information to the M2M device. That is, the M2M device may receive updated MGID information from the BS through the AAI-RNG-RSP message. A detailed description of the AAI-RNG-RSP message acting as a location update response message of the BS can be seen from Table 14.

On the other hand, if the ‘action bitmap’ field of the AAI-PAG-ADV message is set to ‘bit #3’, the processor 120 of the M2M device can recognize that a control parameter must be updated and can control the execution of a control parameter update operation.

The following Table 2 shows an example of an M2M paging message format different from those of Table 1.

TABLE 2

| | | | |
|---|---|---|---|
| | Size | | |
| Field | (bits) | Value/Description | Condition |

| | | |
|---|---|---|
| M2M paging message | | |
| format { | | |
| for (i=0; i< Num_M2M | | |
| Group; i++) { | | |
| M2M Group ID | TBD | Used to indicate the M2M Group |
| (MGID) | | to be paged. |
| Action Bitmap | 4 | Bit #0: Perform the network |
| | | reentry |
| | | Bit #1: Receives the multicast |
| | | traffic |
| | | Bit #2: Perform ranging for |
| | | location update |
| | | Bit #3: Updates control |
| | | parameters |
| if (Bit #0 in Action | | |
| Bitmap == 1) { | | |
| Action Type | 1 | 0: It indicates the group network |
| | | reentry. All M2M devices belong |
| | | to M2M Group shall perform the |
| | | network reentry. |
| | | 1: It indicates the network reentry |
| | | of individual M2M devices. M2M |
| | | Device ID is used to indicate the |
| | | individual M2M device. Indicated |
| | | M2M device using the M2M |
| | | Device ID performs the network |
| | | reentry. |
| if (Action Type == 1) { | | |
| for (i=0; i< Num_M2M | | |
| Device ID; i++) { | | |
| M2M Device ID | TBD | Used to indicate the M2M device |
| (MDID) | | to be paged. |
| } | | |
| } | | |
| if (Bit #2 in Action | | |
| Bitmap == 1) { | | |
| Action Type | 1 | 0: It indicates the group location |
| | | update. All M2M devices belong |
| | | to M2M Group shall perform the |
| | | location update. |
| | | 1: It indicates the location update |
| | | of individual M2M devices. M2M |
| | | Device ID is used to indicate the |
| | | individual M2M device. Indicated |
| | | M2M device using the M2M |
| | | Device ID performs the location |
| | | update. |
| if (Action Type == 1) { | | |
| for (i=0; i< Num_M2M | | |
| Device ID; i++) { | | |
| M2M Device ID | | Used to indicate the M2M device |
| (MDID) | | to be paged. |
| } | | |
| } | | |
| if (Bit #3 in Action | | //Group wise control parameter |
| Bitmap == 1) { | | update |
| Paging Unavailable | | Paging Unavailable Interval to the |
| Interval | | M2M device |
| Paging Cycle | | Paging cycle applied to the M2M |
| | | device |
| M2M Group ID | | Used to indicate the M2M Group |
| (MGID) | | to be paged. |
| } | | |
| } //End of for (i=0; i< | | |
| Num_M2M Group; | | |
| i++) | | |
| }//End of M2M Group | | |
| paging message format | | |

Referring to Table 2, the M2M paging message may include an MGID field, an action bitmap field, etc. For example, if the ‘action bitmap’ field is set to Bit #2, this means ranging execution for location update. If the ‘action bitmap’ field is set to Bit #3, this means that a control parameter must be updated.

If the ‘action bitmap’ field of the M2M paging message is set to Bit #2, the processor 120 of the M2M device can recognize the ranging execution of location update. Accordingly, the M2M device may transmit the ranging request message (AAI-PAG-ADV) for location update to the BS. If location update has been successful, the BS can indicate the success of location update through the ranging response message (e.g., AAI-RNG-RSP message), and at the same time can transmit the resultant information including updated MGID information to the M2M device. That is, the M2M device may receive the updated MGID information from the BS through the ranging response message (AAI-PAG-ADV). A detailed description of the ranging response message (AAI-PAG-ADV) acting as a location update response message of the BS can be seen from Table 14.

On the other hand, if the ‘action bitmap’ field of the received AAI-PAG-ADV message is set to Bit #3, the processor 120 of the M2M device can recognize that a control message must be updated, such that it can update a control parameter.

The embodiment of the present invention provides a method for updating a control parameter through the paging message, and also provides an error handling method when no paging message is received.

The M2M device can confirm a superframe header (SFH) and a paging group ID (PGID) message in its own paging available interval, and can confirm whether or not its own paging group has been changed. In addition, the M2M device receives the paging message in the paging available interval. The processor 120 of the M2M device determines that the paging group has been changed when a paging group ID of the processor 120 has not been detected in the PGID information message received in the paging listening interval of the processor 120. Then, the M2M device performs location update, such that it can receive new paging parameters (for example, paging cycle, paging offset, DID, etc.)

In addition, the BS may transmit a PGID information message and a paging message to the M2M device in response to the paging listening interval of the M2M devices. If the M2M device moves to another BS and does not receive the PGID information and the paging message during its paging available interval, the processor 120 of the M2M device determines that the processor 120 has moved to another paging group such that it can perform location update. For reference, PGID information is always transmitted during the paging available interval of the M2M device. Although paging for the M2M device is not performed, the paging message (paging group ID bitmap of the M2M device is set to zero) can be transferred.

The paging message reception and location update procedure of the above-mentioned M2M device is associated with a method for updating reliable control parameters through the paging message, and a detailed description thereof will hereinafter be described in detail.

The paging controller transmits a paging parameter of the idle-mode M2M devices to the BS contained in its own paging group region so as to update a paging parameter of the idle-mode M2M devices. The BS includes the updated paging parameter of the idle-mode M2M devices in the paging message, and then broadcasts the resultant paging message to the M2M devices. If the M2M device receives the paging message during its own paging available interval, the update paging parameter is applied to the M2M device, such that the M2M device performs the idle-mode operation.

The M2M device having received the paging message need not inform the BS of the updated parameters. The paging message broadcast by the BS is transmitted to at a sufficiently robust MCS (Modulation and Coding Scheme), such that it is assumed that the M2M device successfully receives the parameters in so far as the channel environment is not suddenly deteriorated. If the M2M device receives the paging message including the updated paging parameter (or other control parameters) during its own paging available period, the confirmation message is not transmitted to the BS.

However, although the processor of the M2M device confirms the SFH during the its own paging available interval and checks the serving BS, assuming that the PGID information message and the paging message are not received, the M2M device may request retransmission of the paging message from the BS. The M2M device transmits the paging request message (for example, AAI-PAG-ADV-REQ message) to the BS as soon as the paging available interval is terminated, and waits for receiving a response to the paging request message.

If the M2M device does not receive the paging message, a unicast MAC control message for requesting retransmission of the paging message can be defined as shown in Tables 3 and 4. Table 3 shows an example of the paging request message (AAI-PAG-ADV-REQ) format, and Table 4 shows an example of the paging response message (AAI-PAG-ADV-RSP) format.

TABLE 3

| | | | |
|---|---|---|---|
| | Size | | |
| Field | (bits) | Value/Description | Condition |

AAI-PAG-ADV-REQ
( ) {
}

TABLE 4

| | | | |
|---|---|---|---|
| | Size | | |
| Field | (bits) | Value/Description | Condition |

AAI-PAG-ADV-RSP ( )
{
Parameters having been
transmitted to the M2M
device through the
AAI-PAG-ADV
message are included
(See Tables 1 and 2).
}

When the BS transmits the AAI-PAG-ADV-RSP message to the M2M device, a (poll) bit of a MAC Control Extended header (MCEH) is set to 1, such that the BS can receive an ACK message (for example, MAEH (MAC Control Ack Extended header) or AAI-MSG-ACK message) from the M2M device. In this case, the AAI-MSG-ACK message is used to indicate reception of the MAC control message.

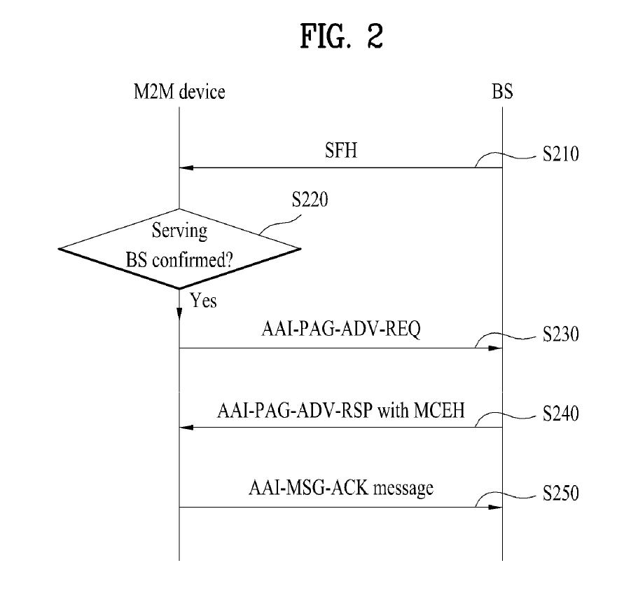

FIG. 2 is a flowchart illustrating a method for requesting retransmission of the paging message when an M2M device does not receive the paging message according to one embodiment of the present invention.

FIG. 2 is a flowchart illustrating a recover method for use in the case that the M2M device does not receive the paging message. Referring to FIG. 2, the M2M device can receive the SFH during its own paging available interval in step S210. The processor 120 of the M2M device can confirm the received SFH such that it can determine the presence or absence of a serving BS ID in step S220. In addition, the processor 120 of the M2M device confirms the PGID information message, such that it can confirm its own PGID. The M2M device may not receive the paging message during the paging available interval, such that the M2M device can transmit the paging request message (for example, AAI-PAG-ADV-REQ message) for requesting retransmission of the paging message to the BS in step S230. Thereafter, the BS may transmit the paging response message (AAI-PAG-ADV-RSP) as a response to the paging request message (AAI-PAG-ADV-REQ) to the M2M device in step S240.

The AAI-PAG-ADV-RSP message may include parameters contained in the pre-transmitted AAI-PAG-ADV message. A poll bit of the MCEG of the AAI-PAG-ADV-RSP message is set to 1 by the BS, such that the BS can receive the ACK signal from the M2M device. The M2M device receives the AAI-PAG-ADV-RSP message, confirms that the poll bit of the MCEH is set to 1, and transmits the AAI-MSG-ACK message in step S250.

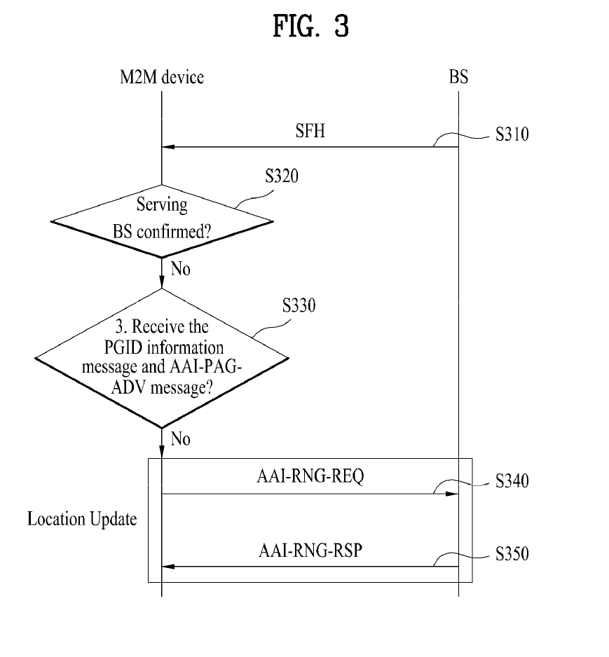

FIG. 3 is a flowchart illustrating a method for requesting the paging message when the M2M device does not receive the paging message according to another embodiment of the present invention.

In FIG. 3, the M2M device confirms the SFH during its own paging interval, it is confirmed that the M2M device moves to another BS and at the same time the M2M device performs location update upon receiving no PGID information message and no paging message.

Referring to FIG. 3, the M2M device can receive the SFH from the BS during its own paging available interval in step S310, and can confirm the presence or absence of the serving BS ID by confirmation of the SFH in step S320. If another BS ID instead of the serving BS ID is confirmed, the M2M device can determine whether the PGID information message and the paging message have been received during the paging available interval in step S330. Assuming that the M2M device does not receive the PGID information message and the paging message, it is determined that the M2M device has moved to another paging group in step S330. Thereafter, the M2M device transmits the raging request message (for example, AAI-RNG-REQ) to the BS, such that it can perform location update in step S340. As a response to the ranging request message (AAI-RNG-REQ) of the M2M device, the BS may transmit the ranging response message (for example, AAI-RNG-RSP message) to the M2M device in step S350.

In addition, the present invention provides a method for requesting retransmission when the paging message is not received through the idle-mode location update message (for example, AAI-RNG-REQ/RSP). That is, assuming that the M2M device has missed this paging message, the M2M device may transmit the ranging request message (for example, AAI-RNG-REQ) established by the idle-mode location update for requesting a ranging purpose indication message (for example, 0b1110=AAI-PAG-ADV message) to the BS. In this case, an example of the transmitted ranging request message is shown in Table 5.

TABLE 5

| | | | |
|---|---|---|---|
| | Size | | |
| Field | (bits) | Value/Description | Condition |

| | | |
|---|---|---|
| AAI-RNG-REQ | | |
| ( ) { | | |
| Ranging Purpose | 4 | 0b0000 = Initial network entry |
| Indication | | 0b0001 = HO reentry |
| | | 0b0010 = Network reentry from |
| | | idle mode |
| | | 0b0011 = Idle mode location |
| | | update |
| | | 0b0100 = DCR mode extension |
| | | 0b0101 = Emergency call setup |
| | | (e.g., E911) |
| | | 0b0110 = Location update for |
| | | updating service flow management |
| | | encodings of E-MBS flows |
| | | 0b0111 = Location update for |
| | | transition to DCR mode from idle |
| | | mode |
| | | 0b1000 = Reentry from DCR |
| | | mode, coverage loss or detection |
| | | of different ABS restart count. |
| | | 0b1001 = Network reentry from a |
| | | Legacy BS |
| | | 0b1010 = Zone switch to MZONE |
| | | from LZONE |
| | | 0b1011 = Location update due to |
| | | power down. |
| | | 0b1100 = Interference mitigation |
| | | request to a CSG Femto ABS |
| | | when experiencing interference |
| | | from the CSG Femto ABS |
| | | 0b1101 = NS/EP call setup |
| | | 0b1110 = Idle mode location |
| | | update for requesting the AAI- |
| | | PAG-ADV message |
| | | 0b1111 = reserved |
| } | | |

Upon receiving the ranging request message in which the ranging purpose indication is set to ‘idle mode location update’ for requesting the ‘0b1110=AAI-PAG-ADV’ message, the BS may transmit the ranging response message (for example, AAI-RNG-RSP) in which a location update response indicates ‘0x06=success of location update” and ‘retransmission of AAI-PAG-ADV message’ to the M2M device, and may retransmit the paging message (AAI-PAG-ADV). In this case, as can be seen from Table 6 showing an example of the AAI-RNG-RSP message format, the BS may include a frame or subframe number needed for retransmission of the AAI-PAG-ADV message in the AAI-RNG-RSP message, and may transmit the resultant AAI-RNG-RSP message to the M2M device. That is, the M2M device may receive the AAI-PAG-ADV message retransmitted by the BS in the AAI-PAG-ADV retransmission frame included in the AAI-RNG-RSP message.

TABLE 6

| | Size | | |
|---|---|---|---|
| Field | (bits) | Value/Description | Condition |
| AAI-RNG-RSP ( ) { | | | |
| Location Update Response | 4 | 0x0 = Success of Location | Shall be included |
| | | Update | when this |
| | | 0x1 = Failure of Location | message is sent |
| | | Update | in response to an |
| | | 0x2 = Reserved | AAIRNG-REQ |
| | | 0x3 = Success of location | message used to |
| | | update and DL traffic | perform location |
| | | pending | update or DCR |
| | | 0x4 = Allow AMS's DCR | mode initiation |
| | | mode initiation request or | from Idle Mode |
| | | DCR mode extension | or DCR mode |
| | | request | extension or Idle |
| | | 0x5 = Reject AMS's DCR | mode location |
| | | mode initiation request or | update for |
| | | DCR mode extension | requesting the |
| | | request | AAI-PAG-ADV |
| | | 0x6 = Success of location | message. |
| | | update and AAI-PAG-ADV | |
| | | retransmission | |
| | | 0x07~0xF: Reserved | |
| if (Location Update | | | |
| Response == 0x6) { | | | |
| AAI-PAG-ADV | | The BS may indicate the | |
| retransmission frame (or | | frame or subframe number | |
| subframe) | | needed when the AAI-PAG- | |
| | | ADV message is | |
| | | retransmitted to the M2M | |
| | | device. | |
| } | | | |
| } | | | |

The following Table 7 shows one example of another AAI-RNG-RSP format different from those of Table 6.

Likewise, a parameter contained in the paging message that is not received through the AAI-RNG-RS message is included in the AAI-RNG-RSP message, such that the BS can transmit the resultant AAI-RNG-RSP message to the M2M device.

TABLE 7

| | Size | | |
|---|---|---|---|
| Field | (bits) | Value/Description | Condition |
| AAI-RNG-RSP ( ) { | | | |
| Location Update | 4 | 0x0 = Success of Location | Shall be included |
| Response | | Update | when this |
| | | 0x1 = Failure of Location | message is sent |
| | | Update | in response to an |
| | | 0x2 = Reserved | AAIRNG-REQ |
| | | 0x3 = Success of location | message used to |
| | | update and DL traffic | perform location |
| | | pending | update or DCR |
| | | 0x4 = Allow AMS's DCR | mode initiation |
| | | mode initiation request or | from Idle Mode |
| | | DCR mode extension | or DCR mode |
| | | request | extension or Idle |
| | | 0x5 = Reject AMS's DCR | mode location |
| | | mode initiation request or | update for |
| | | DCR mode extension | requesting the |
| | | request | AAI-PAG-ADV |
| | | 0x6 = Success of location | message. |
| | | update and AAI-PAG-ADV | |
| | | retransmission | |
| | | 0x07~0xF: Reserved | |
| if (Location Update | | | |
| Response == 0x6) { | | | |
| Parameters transmitted | | Parameters transmitted from | |
| from the BS to the | | the BS to the M2M device | |
| M2M device through | | through the AAI-PAG-ADV | |
| the AAI-PAG-ADV | | message are included. | |
| message. | | | |
| } | | | |
| } | | | |

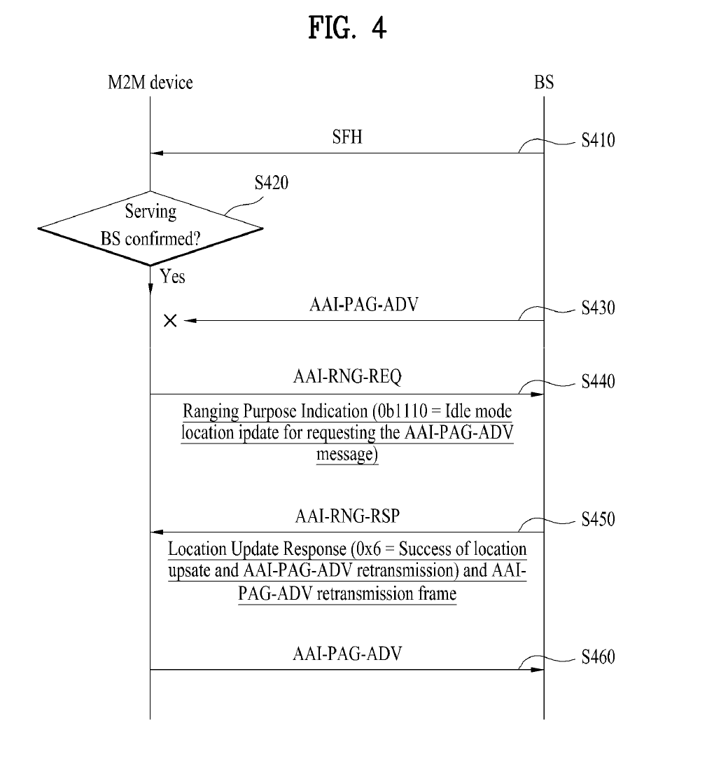

FIG. 4 is a flowchart illustrating a method for enabling the M2M device to request retransmission of the AAI-PAG-ADV message through location update according to embodiments.

Referring to FIG. 4, the M2M device can receive the SFH from the BS during its own paging available interval in step S410. In this case, the processor 120 of the M2M device confirms the received SFH such that it can determine the presence or absence of the serving BS ID in step S420. In addition, the processor 120 of the M2M device may confirm the PGID information message so that it may confirm its own PGID. The M2M device may not receive the paging message during the paging available interval, so that the M2M device may request retransmission of the paging message in step S430. In this case, there are four cases in which the M2M device may request retransmission of the paging message from the BS, and a detailed description thereof is as follows.

<Case 1: In Accordance with the Scenario of Case 1, Although the M2M Device to be Paged by the BS is not Present, the Paging Message is Always Transmitted to the Paging Listening Interval of the M2M Device>

If the M2M device does not receive the paging message during its own paging listening interval, the M2M device may request retransmission of the paging message from the BS through location update (i.e., the ranging purpose indication is set to 0b110 so that the AAI-RNG-REQ message is transmitted) in step S430.

In contrast, assuming that the paging message is not received at least a threshold number of times to prevent frequent location update of the M2M device, the M2M device may request retransmission of the paging message from the BS through location update. The threshold number of times may be transferred from the BS to the M2M device through the AAI-DREG-RSP message during the idle mode initiation. For example, assuming that the threshold number of times is set to 3 (i.e., threshold 3) through the AAI-DREG-RSP message during the idle mode initiation, the M2M device may transmit the AAI-RNG-REQ message for requesting retransmission of the paging message to the BS in so far as the M2M device does not receive the paging message during each paging listening interval of three paging cycles. As a result, frequent location update (location update for retransmission of the paging message) of the M2M device can be prevented from occurring. The threshold number of times for a request of the paging message retransmission can be differently applied to respective M2M devices. That is, different values may be allocated by the network according to service characteristics (UL traffic, DL traffic transmission period, etc.) of the M2M device.

Table 8 shows an example of the AAI-DREG-RSP message format including specific information indicating the threshold number of times for requesting retransmission of the paging message.

TABLE 8

| | Size | | |
|---|---|---|---|
| Field | (bits) | Value/Description | Condition |
| AAI-DREG-RSP | | | |
| message ( ) { | | | |
| . . . | | | |
| paging message | 2 | Paging cycle threshold for | Optional) The |
| retransmission | | permitting the paging | corresponding |
| threshold | | message missing of the | parameter is |
| | | M2M device. | included only for |
| | | Example) If a threshold | the M2M device |
| | | value is set top 2, the M2M | having the short |
| | | device does not request | paging cycle. |
| | | retransmission of the | The BS does not |
| | | paging message although | allocate the |
| | | the M2M device has | corresponding |
| | | missed the paging | parameter to the |
| | | message during one | M2M device |
| | | paging cycle. | having a long |
| | | If no paging message is | paging cycle. |
| | | received during two paging | |
| | | cycles, the M2M device | |
| | | performs location update | |
| | | for the BS, and requests | |
| | | retransmission of the | |
| | | paging message. | |
| . . . | | | |
| } | | | |

A new location update condition can be defined on the basis of a threshold number of paging retransmission times as can be seen from Table 8. If the M2M device does not receive as many paging messages as the threshold number of times, the AAI-RNG-REQ message (the ranging purpose indication field is set to 0b1110 as shown in Table 5) is transmitted to the BS, such that location update can be performed.

<Case 2: In Accordance with the Scenario of Case 2, No Paging Message is Transmitted to the Paging Listening Interval when the M2M Device to be Paged is not Present>

Although the M2M device to be paged is not present according to the scenario in which the threshold number of times is established in Case 1, there may occur overhead through which the paging message is always transmitted. Therefore, the present invention provides a method for indicating whether or not the paging message is received before the BS transmits the paging message to the M2M device, resulting in reduction of overhead. That is, bit-sized bitmap is defined in PGID information, such that transmission or non-transmission of the paging message can be indicated. The indication message may be composed of 4 bits, and a detailed description thereof is as follows.

During the idle mode of the IEEE 802.16m system, the idle-mode M2M device can implicitly recognize a specific frame in which the paging message is to be received within the paging listening interval through a Deregistration ID (DID) mode ‘m’ operation (where m=1, 2, 3, 4). Therefore, 4-bit indication bitmap may indicate transmission or non-transmission of the paging message per frame monitored by the M2M device. The M2M device confirms the 4-bit indication bitmap contained in PGID information, such that it can detect the presence or absence of the paging message transmitted to the M2M device itself. For example, assuming that the frame to be monitored by the M2M device through ‘DID modulo m’ is a second frame, the M2M device confirms a second bit of the 4-bit indication bitmap of the PGID information message, such that it can determine the presence or absence of the paging message transmitted to the M2M device.

In accordance with another embodiment, the paging frame indication bitmap may have the same size as the ‘m’ value transmitted through the conventional PGID information message. For example, if the ‘m’ value is set to 1, the paging frame indication message includes the size of 1 bit. If the ‘m’ value is set to 2, the bitmap size is 2 bits. If the ‘m’ value is set to 3, the bitmap size is 3 bits. If the ‘m’ value is set to 4, the bitmap size is 4 bits. The ‘m’ value transmitted through the conventional PGID information message is used by the M2M device configured to decide a frame through which the paging message is transmitted to the M2M device. The M2M device may recognize a frame number (or index) related to reception of the paging message to be transmitted to the M2M device on the basis of the remaining values obtained by the ‘DID modulo m’ operation.

In accordance with another embodiment, the paging indication message may be defined as a 1-bit indication message instead of bitmap as necessary. That is, assuming that the processor 120 of the M2M device confirms that the paging indication parameter of the PGID information is set to 1, the processor 120 can monitor the paging message within its paging listening interval.

Table 9 shows an example of the PGID information message format including the paging indication bitmap proposed by the embodiment.

TABLE 9

| Field | Size (bits) | Value/Description | Condition |
|---|---|---|---|
| PGID information | | | |
| message ( ) { | | | |
| . . . | | | |
| Paging indication | 4 or variable | 1: This value indicates whether or | |
| bitmap | (according | not the paging message is | |
| | to ‘m’ value | transmitted to a first frame of the | |
| | of PGID | paging listening interval. If the | |
| | information) | value of 1 is set, this means | |
| | | transmission of the paging | |
| | | message. | |
| | | 2: This value indicates whether the | |
| | | paging message is transmitted to a | |
| | | second frame of the paging | |
| | | listening interval. If the value of 1 | |
| | | is set, this means transmission of | |
| | | the paging message. | |
| | | 3: This value indicates whether the | |
| | | paging message is transmitted to a | |
| | | third frame of the paging listening | |
| | | interval. If the value of 1 is set, | |
| | | this means transmission of the | |
| | | paging message. | |
| | | 4: This value indicates whether the | |
| | | paging message is transmitted to a | |
| | | fourth frame of the paging | |
| | | listening interval. If the value of 1 | |
| | | is set, this means transmission of | |
| | | the paging message. | |
| . . . | | | |
| } | | | |

Referring to Table 9, the PGID information message may further include the paging indication bitmap field composed of 4 bits. Assuming that the M2M device receives the PGID information message including the paging indication bitmap field composed of 4 bits, the M2M device can recognize which one of frames of the paging listening interval will include the paging message.

Table 10 shows another embodiment of the PGID information message format.

TABLE 10

| | | | |
|---|---|---|---|
| | Size | | |
| Field | (bits) | Value/Description | Condition |

| | | |
|---|---|---|
| PGID information | | |
| message ( ) { | | |
| . . . | | |
| Paging indication | 1 | 0: No paging message is |
| | | transmitted to the paging |
| | | listening interval. |
| | | 1: Paging message is |
| | | transmitted to the paging |
| | | listening interval. |
| . . . | | |
| } | | |

Referring to Table 10, the PGID message may define a 1-bit sized parameter and use the parameter composed of 1 bit. For example, if the paging indication field is set to zero (0), this means that no paging message is transmitted to the paging listening interval. In contrast, if the paging indication field is set to 1, this means that the paging message is transmitted to the paging listening interval.

Table 11 shows another embodiment of the PGID information message format.

TABLE 11

| | Size | | |
|---|---|---|---|
| Field | (bits) | Value/Description | Condition |
| PGID information | | | |
| message ( ) { | | | |
| . . . | | | |
| Paging indication | 4 | 1: This value indicates whether or | |
| bitmap | | not the paging message is | |
| | | transmitted to a first frame of the | |
| | | paging listening interval. If the | |
| | | value of 1 is set, this means | |
| | | transmission of the paging message. | |
| | | 2: This value indicates whether the | |
| | | paging message is transmitted to a | |
| | | second frame of the paging listening | |
| | | interval. If the value of 1 is set, this | |
| | | means transmission of the paging | |
| | | message. | |
| | | 3: This value indicates whether the | |
| | | paging message is transmitted to a | |
| | | third frame of the paging listening | |
| | | interval. If the value of 1 is set, this | |
| | | means transmission of the paging | |
| | | message. | |
| | | 4: This value indicates whether the | |
| | | paging message is transmitted to a | |
| | | fourth frame of the paging listening | |
| | | interval. If the value of 1 is set, this | |
| | | means transmission of the paging | |
| | | message. | |
| For (i= 0: i<Num | | Multicast traffic indication | |
| positive indication; i++) | | messages are included by the | |
| { | | number of paging indication | |
| | | bitmaps of ‘1’. | |
| Multicast traffic | | 0: This means that multicast traffic | |
| indication | | is not transmitted. | |
| | | 1: This means that multicast traffic | |
| | | is transmitted. | |
| } | | | |
| . . . | | | |
| } | | | |

Referring to Table 11, the PGID information message may further include not only the paging indication bitmap field but also the multicast traffic indication field. Here, the paging indication bitmap field indicates when the paging message will be transmitted in the paging listening interval. If the multicast traffic indication field is set to zero (0), this means non-transmission of the multicast traffic. In contrast, if the multicast traffic indication field is set to 1, this means transmission of the multicast traffic. The M2M device receives the PGID information message shown in Table 11, such that it can additionally recognize specific information indicating whether multicast traffic is transmitted.

Although the M2M device confirms that the paging message is transmitted through the 4-bit indication bitmap of the PGID information message, assuming that the M2M device does not receive the paging message within its own paging listening interval, the M2M device may request retransmission of the paging message from the BS through location update.

In accordance with the embodiment of the present invention, assuming that the paging message to be transmitted to the paging listening interval (i.e., current superframe) of the M2M device, the BS further includes a specific field indicating the absence of a paging message to be transmitted in the corresponding information, such that the BS can transmit the resultant information to the M2M device. Table 12 shows another embodiment of the PGID information message format.

TABLE 12

| | Size | | |
|---|---|---|---|
| Field | (bits) | Value/Description | Condition |
| } // End If | | | |
| (an ABS | | | |
| supports | | | |
| multiple | | | |
| carrier | | | |
| operation) | | | |
| paging | 1 | 1: paging message which is notifying | This parameter shall be |
| message | | the M2M devices will not be | presented when the paging |
| Indication | | transmitted in the current superframe. | message does not transmit |
| | | | in the current superframe. |
| | | | This parameter is only |
| | | | useful for the M2M device. |

Referring to Table 12, the PGID message may include the paging message indication field for indicating the presence or absence of the paging message to be transmitted to the M2M device within the current superframe. The processor 120 of the M2M device decodes the paging message indication, such that it can recognize whether the paging message is transmitted within the current superframe. If the processor 120 of the M2M device confirms that the paging message is not transmitted through the PGID information message within its own paging listening interval (for example, through the paging message indication field), the processor 120 enters the paging unavailable interval so as to implement power saving.

A method for performing groupwise paging update through the control parameter update indication (or paging parameter update indication) will hereinafter be described.

As described above, the present invention proposes a method for updating the paging parameter of the M2M device through the group paging scheme. In addition, the present invention proposes a method for enabling the M2M device having not received the paging message to receive again the missed paging message through location update. However, assuming that paging of the M2M device is performed for the paging parameter update or control parameter update, and the M2M device does not receive the paging message within its own paging cycle, although the M2M device receives the paging message within the next paging cycle without location update, no problem occurs. Therefore, the present invention provides the 1-bit indication field configured to indicate whether the paging message transmitted from the BS is used for general paging, for control parameter update, or for paging parameter update.

That is, when the BS transmits the paging message for the control parameter or paging parameter update of the M2M device, the BS may indicate transmission of the paging message so as to update either the control parameter or the paging parameter through the PGID information message obtained before transmission of the paging message. Table 13 shows another embodiment of the PGID information message format.

TABLE 13

| | Size | | |
|---|---|---|---|
| Field | (bits) | Value/Description | Condition |
| } // End If (an | | | |
| ABS supports | | | |
| multiple carrier | | | |
| operation) | | | |
| Paging Message | 1 | 1: Paging message which is notifying the | This parameter |
| Indication | | M2M devices will not be transmitted in | shall be |
| | | the current superframe. | presented when |
| | | | the paging |
| | | | message does |
| | | | not transmit in |
| | | | the current |
| | | | superframe. |
| | | | This parameter |
| | | | is only useful |
| | | | for the M2M |
| | | | device. |
| Control Parameter | 1 | This indicates that ABS transmits the | Optional |
| Update Indication | | AAI-PAG-ADV message for the purpose | Shall be present |
| (or Paging | | of updating the control parameter (or | when the ABS |
| Parameter | | updating the paging parameter) of M2M | transmits the |
| Indication) | | devices in the current superframe | AAI-PAG-ADV |
| | | | message to the |
| | | | M2M devices |
| | | | for the purpose |
| | | | of updating the |
| | | | control |
| | | | parameter (or |
| | | | updating the |
| | | | paging |
| | | | parameter) |

Referring to Table 13, the PGID information message may include a control parameter (or paging parameter) indication field indicating that the BS transmits the paging message for updating the control parameter (or paging parameter) of the M2M device during the current superframe. If the M2M device staying in the paging listening interval receives an indication message indicating that the paging message is transmitted to update the control parameter (or paging parameter) within the current superframe through the PGID information message shown in Table 13, the processor 120 of the M2M device can update the updated parameter upon receiving the paging message. The application time of the updated parameter may be used as the next paging cycle. Although the M2M device receives an indication message of the control parameter update, assuming that the M2M device does not receive the paging message during its own paging listening interval, the M2M device performs location update after waiting for the current paging listening interval. In addition, the M2M device may receive the updated parameter through the location update response message (for example, AAI-RNG-RSP message).

In another aspect of the present invention, assuming that the M2M device does not receive the paging message during its own paging listening interval, waits for a paging listening interval of the next paging cycle, and does not receive the paging message within the paging listening interval of the next paging cycle, the M2M device can perform location update and can receive the updated control parameter through the location update response message (for example, AAI-RNG-RSP message).

Table 14 shows an example of the AAI-RNG-RSP message acting as a location update response message.

TABLE 14

| Field | Size (bits) | Value/Description | Condition |
|---|---|---|---|
| AAI-RNG-RSP ( ) { | | | |
| Location Update | 4 | 0x0 = Success of Location | Shall be included |
| Response | | Update | when this |
| | | 0x1 = Failure of Location | message is sent |
| | | Update | in response to an |
| | | 0x2 = Reserved | AAI-RNG-REQ |
| | | 0x3 = Success of location | message used to |
| | | update and DL traffic | perform location |
| | | pending | update or DCR |
| | | 0x4 = Allow AMS's DCR | mode initiation |
| | | mode initiation request or | from Idle Mode |
| | | DCR mode extension | or DCR mode |
| | | request | extension |
| | | 0x5 = Reject AMS's DCR | |
| | | mode initiation request or | |
| | | DCR mode extension | |
| | | request | |
| | | 0x06~0xF: Reserved | |
| if (Location Update | | | |
| Response == 0x0) { | | | |
| . . . | | | |
| New Paging Cycle | 4 | | This is included |
| | | | only when update |
| | | | is performed. |
| New Paging Offset | 12 | | This is included |
| | | | only when update |
| | | | is performed. |
| New MGID | 15 | M2M Group ID | This is included |
| | | | only when update |
| | | | is performed. |
| . . . | | | |
| } | | | |
| } | | | |

It the M2M device having missed the paging message does not receive the updated parameter, the BS may update the updated parameter through the location update response (AAI-RNG-RSP) message. The AAI-RNG-RSP message may include a location update response field. If the location update response field is exemplarily set to ‘0x0’, this means the success of location update. If the location update has been successfully performed, the BS may include a new paging cycle field indicating a new paging cycle, a new paging offset field indicating a new paging offset, and an MGID field indicating an M2M group ID into the AAI-RNG-RSP message, and then transmit the resultant AAI-RNG-RSP message to the M2M device.

Exemplary embodiments described hereinbelow are combinations of elements and features of the present invention. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. Also, it will be obvious to those skilled in the art that claims that are not explicitly cited in the appended claims may be presented in combination as an exemplary embodiment of the present invention or included as a new claim by subsequent amendment after the application is filed.

It will be apparent to those skilled in the art that various modifications and variations can be made in the present invention without departing from the spirit or scope of the invention. Therefore, the above-mentioned detailed description must be considered for illustrative purposes only, not restrictive purposes. The scope of the present invention must be decided by a rational analysis of the claims, and all modifications within equivalent ranges of the present invention are within the scope of the present invention.

### INDUSTRIAL APPLICABILITY

The method and apparatus for transmitting and receiving parameter update information according to the embodiments of the present invention can be applied to various mobile communication systems, for example, 3GPP LTE, LTE-A, IEEE 802, etc. for industrial purposes.

1. A method for transmitting parameter update information by a base station (BS) in a wireless communication system, the method comprising:
transmitting a first message including information indicate that at least one M2M device contained in a specific M2M (Machine to Machine) group needs to perform a location update, to the at least one M2M device;
receiving a second message for the location update from the at least one M2M device; and
transmitting a third message as a response to the second message to the at least one M2M device,
wherein the third message includes new M2M group identifier (ID) information of the at least one M2M device belonging to the specific M2M group.

2. The method according to claim 1, wherein the first message is a paging message, the second message is a ranging request message, and a third message is a ranging response message.

3. The method according to claim 2, wherein the at least one M2M device contained in the specific M2M group operates in an idle mode.

4. The method according to claim 3, wherein the paging message corresponds to a paging message based on an M2M group.

5. A method for receiving parameter update information by an M2M (Machine to Machine) device in a wireless communication system, comprising:
receiving a first message including specific information indicate that at least one M2M device contained in a specific M2M (Machine to Machine) group needs to perform a location update, from a base station (BS);
transmitting a second message for the location update from the at least one M2M device; and
receiving a third message as a response to the second message from the base station (BS),
wherein the third message includes new M2M group identifier (ID) information of the at least one M2M device belonging to the specific M2M group.

6. The method according to claim 5, wherein the first message is a paging message, the second message is a ranging request message, and a third message is a ranging response message.

7. The method according to claim 6, wherein the at least one M2M device contained in the specific M2M group operates in an idle mode.

8. The method according to claim 7, wherein the paging message corresponds to a paging message based on an M2M group.

9. A base station (BS) for transmitting parameter update information in a wireless communication system, the BS comprising:
a transmitter configured to transmit a first message including specific information indicating that at least one M2M device contained in a specific M2M (Machine to Machine) group needs to perform a location update, to the at least one M2M device; and
a receiver configured to receive a second message for location update from the at least one M2M device,
wherein the transmitter further transmits a third message as a response to the second message to the at least one M2M device, and the third message includes new M2M group identifier (ID) information of the at least one M2M device belonging to the specific M2M group.

10. A Machine to Machine (M2M) device for receiving parameter update information in a wireless communication system, the M2M device comprising:
a receiver configured to receive a first message including specific information indicate that the M2M device contained in a specific M2M (Machine to Machine) needs to perform a location update, from a base station (BS); and
a transmitter configured to transmit a second message for the location update from the base station (BS),
wherein the receiver further receives a third message as a response to the second message from the base station (BS), and the third message includes new M2M group identifier (ID) information of the M2M device belonging to the specific M2M group.

11. The M2M device according to claim 10, wherein the first message is a paging message, the second message is a ranging request message, and a third message is a ranging response message.

12. The M2M device according to claim 11, wherein the paging message corresponds to a paging message based on an M2M group.
